(19) United States
(12) Patent Application Publication
(10) Pub. No.: US 2004/0215585 A1
(43) Pub. Date: Oct. 28, 2004

(54) Data processor

(76) Inventor: Simon Charles Benjamin, Oxford (GB)

Correspondence Address: Nixon & Vanderhye, 1100 North Glebe Road 8th Floor, Arlington, VA, 22201-4714, US

(21) Appl. No.: 10/019,951

(22) PCT Filed: Jul. 5, 2000
(86) PCT No.: PCT/GB00/02573

(30) Foreign Application Priority Data
Jul. 9, 1999 (GB) 9916209.1

(51) Int. Cl. G06N 5/02

(52) U.S. Cl. 706/14; 706/29

(57) ABSTRACT

A data processor which comprises a line of unit cells of alternating type, each capable of adopting two distinguishable states. The states of the cells of each respective type can be transformed (e.g. switched from one state to the other) by respective stimulae (which act on all cells of that type simultaneously) in dependence upon whether the cells two nearest neighbours in the line are both in mutually the same state or in mutually different states. Binary data bits are each represented by a pattern of states of four adjacent cells, and data is loaded onto the cells so that each bit is spaced by four cells from an adjacent bit. Logical operations can be performed on the data by loading a control unit (a particular pattern of states of six adjacent cells) and then applying the stimulae to transform the states of the cells. The processor can be implemented on a conventional computer by implementing the cells as Boolean variables in an array with the stimulae being update rules applied to the array. Alternatively the processor can be implemented as a quantum computer in which the cells are quantum systems (e.g. quantum dots, trapped ions, atomic or molecular spins) which have two eigenstates.

The present invention relates to a data processor which can be loaded with data and perform logical operations on that data. It is particularly concerned with a data processor in the form of a cellular automaton made from unit cells which respond to control signals and interact with each other.

Presently there is tremendous interest in the new field of quantum computation. Quantum computers are thought to offer great advantages in the speed of certain types of task which take current conventional “classical” computers much time. Using quantum computers techniques which are computationally intensive or intractable could be completed very quickly. In a quantum computer, information is stored not as a string of ones and zeros, as in a classical computer, but instead as a series of quantum-mechanical states (eigenstates) of a particle, such as the spin direction of atomic nuclei in a long molecule or of donor impurities in a semi-conductor. Under the laws of quantum mechanics each particle can be in more than one state at a particular time, thus making it possible for each particle in the quantum computer to represent more than one bit of information. These bits are referred to as “qubits” and thus in a binary mode qubits can exist simultaneously as 0 and 1, with the probability for each state being given by a numerical coefficient. It is the fact that the quantum computer can be in multiple states at once, known as superposition, and that it can act on all of its possible states simultaneously, which gives a quantum computer its potential power.

Because a quantum computer works in a fundamentally different way from a classical computer, the architecture of the data processor which is used as the basis for logical operations on data can be quite different.

A data processor which consists of an array of weakly coupled quantum systems has previously been proposed by S Lloyd in “A Potentially Realisable Quantum Computer”; Science, Volume 261, 17 Sep. 1993. Computation is effected by subjecting the array to a sequence of electromagnetic pulses which induce transitions between locally defined quantum states. A one dimensional array, for instance, can consist of localised electron states in a polymer. A two dimensional array can be formed by quantum dots in a semi-conductor. A three dimensional array can be formed by nuclei spins in a crystal lattice. In this system three types of quantum system A, B and C are required in the array, each having two states, e.g. a ground state 0 and an excited state 1. Each bit of data to be processed is represented by the state of one of the systems. Thus the ground and excited state can represent a binary data bit. The systems are arranged in repeating triplets ABCABCABC . . . etc. Each system A, B or C forms a unit cell of the processor. In the absence of interactions between the unit cells, it would be possible to drive the unit cells between the ground and excited states by shining light on the array at the resonant frequency (ω_{A}, ω_{B}, ω_{C}) of the transition for the respective unit cell. By shining light at the resonant frequency ω_{B} of the unit cells of type B, only the cells of type B would be affected, whereas the unit cells of type A and C would be unaltered. In fact the situation is different in practice because physical interactions are present between the unit cells. The effect of this is that the resonant frequency required for inverting a particular cell depends through the interactions on whether the unit cell to its right is in the ground or excited state and whether the unit cell to its left is in the ground or excited state. This gives four possibilities and these different possibilities are used to address the different unit cells.

However, this processor arrangement requires that there are three types of unit cell A, B and C, and the existence of the four distinguishable combinations of state of the left hand or right hand neighbours. These constraints make implementation complex.

The present invention is concerned with providing a data processor architecture which is particularly simple to implement as a quantum computer, though it can also be implemented in a classical computer.

With the present invention each data bit (e.g. binary digit) is represented not by the state of a single unit cell of a processor, but by the pattern of states of a plurality of unit cells. Thus one aspect of the present invention provides a processor in the form of a cellular automaton in which each data bit is represented by a predetermined pattern of states of a plurality of, preferably adjacent, unit cells of the processor.

With this arrangement the physical requirements on the processor can be relaxed as compared to the processor of Lloyd. The processor need have only two type of unit cell as compared with the three types mentioned above.

Thus in another aspect the present invention provides a data processor comprising an array of unit cells of only two different types, the two different types of unit cell being arranged alternately in the array, each unit cell having first and second distinguishable states, and means for independently addressing the two types of unit cell with a state transformation signal to which each addressed unit cell responds by undergoing a state transformation selectively in dependence upon the states of its nearest neighbours in the array.

Another requirement which can be relaxed is the way in which each cell responds to the states of the neighbours. The present invention, in another aspect, provides a processor of the cellular type in which the state transformations of each unit cell occur in dependence upon whether the addressed unit cell's nearest neighbours are in mutually the same state or mutually different states. In one particular implementation, whether or not the transformation is applied is dependent on the value of the “field” which is defined as the number of neighbours in a first state minus the number of neighbours in a second state. Thus it is not necessary to distinguish between left and right hand neighbours.

The above aspects can advantageously be combined.

The array may be one dimensional, such that it consists of a line of unit cells of alternating type. Where the unit cells are quantum systems, with the distinguishable states being different eigenstates, the unit cells can be implemented as the non-zero-spin nuclei of a long molecule, or the non-zero-spin nuclei of donor impurity atoms in a semi-conductor, for instance. The spin of the nuclei can be manipulated by standard NMR techniques, e.g. the use of Π signals at an appropriate resonant frequency to flip the spins of the nuclei, as explained in Lloyd, to effect the desired state transformations. In the quantum implementation the cells can be placed in a quantum superposition of states, e.g. in NMR by using a Π signal of insufficient length to fully flip the spin. The transforms applied should be unitary, i.e. should not cause the quantum states to collapse.

Alternatively, the data processor can be implemented in a classical system, in fact in a conventional computer, with the unit cells being Boolean variables in an array stored in memory. The state transformations to implement different logical operations can then simply be implemented as software rules used to update the array.

In the data processor, data bits (or qubits in a quantum implementation) can be represented on the array as patterns of the first and second states, with each data bit being represented by the pattern of states of several adjacent unit cells.

By unit cells of different types is meant different sub-groups of cells which can be addressed independently of the others. The cells of one type are preferably addressed together, or they can be addressed individually. Further, although the unit cells are addressable in dependence upon the state of their nearest neighbours, they can also be addressed regardless of the state of the nearest neighbours.

In a simple implementation, the state transformation can simply be a switch in the state of the unit cell from one distinguishable state to the other.

Data can be loaded on the array by addressing the unit cells at the edge of the array (where the array is a line, these are the cells at the end of the line) and applying state transformations to them. These unit cells can be addressed separately from the other unit cells in the array because they have fewer neighbours and thus the net perturbative effect of their neighbours is different. In one implementation this corresponds to the set of possible “field” values for the edge cells being completely distinct from the corresponding set of values experienced by non-edge cells. The data loaded onto the edge of the array can be shifted into the array by state transformations applied to all the cells of each type.

In one embodiment data is loaded onto the array so that each data bit is separated from another data bit by a predetermined number of unit cells, and to enable logical operations to be effected a control unit, which is a predetermined pattern of states of a plurality of adjacent cells, is also loaded onto the array.

A parallel processor can be formed by loading a plurality of control units onto the array, each being labelled (e.g. by a unique pattern of states of unit cells associated with it) so that each control unit can be addressed (e.g. to be disabled) independently. Thus another aspect of the invention provides a data processor comprising an array of unit cells of different types, there being a plurality of cells of each of said different types, each unit cell having first and second distinguishable states, and means for independently addressing the different types of unit cell with a state transformation signal to which each addressed unit cell responds by selectively undergoing a state transformation in dependence upon the states of its nearest neighbours, the processor further comprising means for loading a plurality of control units onto the array by setting selected unit cells on the array into predetermined states such that state transformation signals applied to the array cause said state transformations in dependence upon the position of the control units, each of said control units having associated with it a label such that each control unit is individually addressable.

Because the system is capable of implementation either as a quantum computer or as a classical computer, the initial description below will be in general terms applicable to both, and several logical operations and gates will be described. Then some ways of implementing the system in a quantum mechanical computer or in a classical computer will be briefly explained.

The invention will be further described by way of non-limitive example with reference to accompanying drawings, in which:

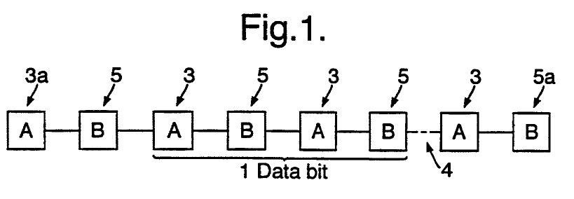

FIG. 1 is a schematic diagram of a data processor according to an embodiment of the invention;

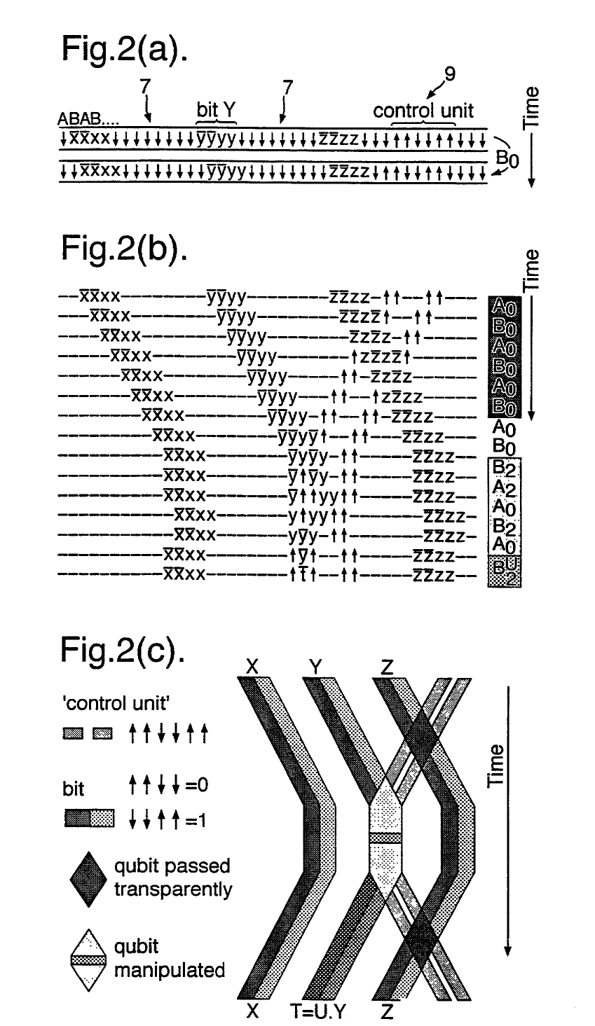

FIG. 2 is a schematic diagram of the processor of FIG. 1 undergoing state transformations to effect an unconditional logical operation on a particular data bit;

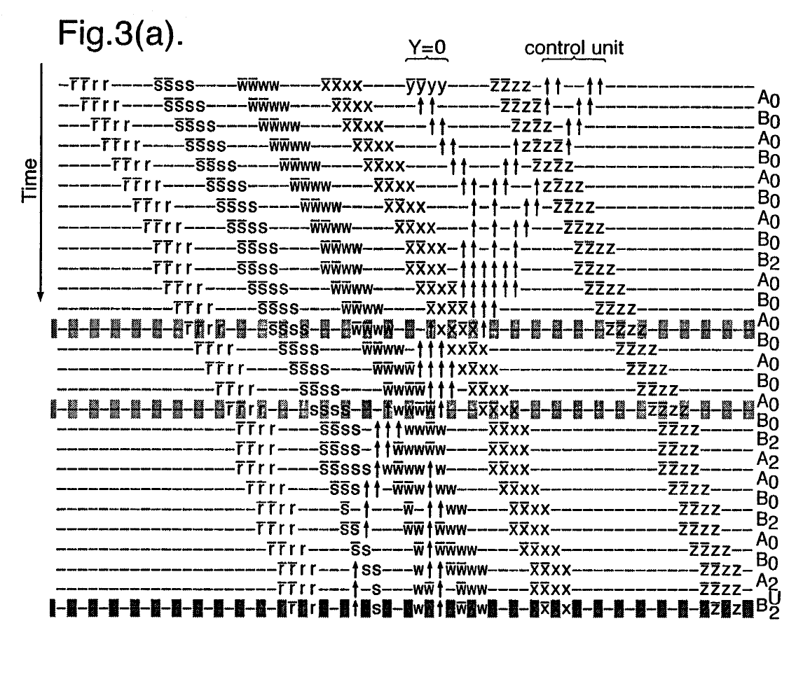

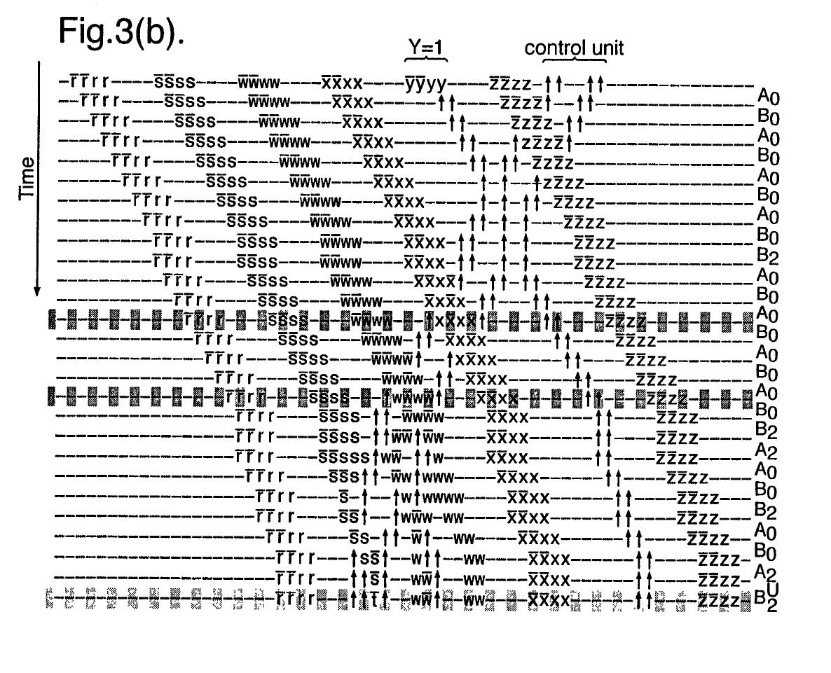

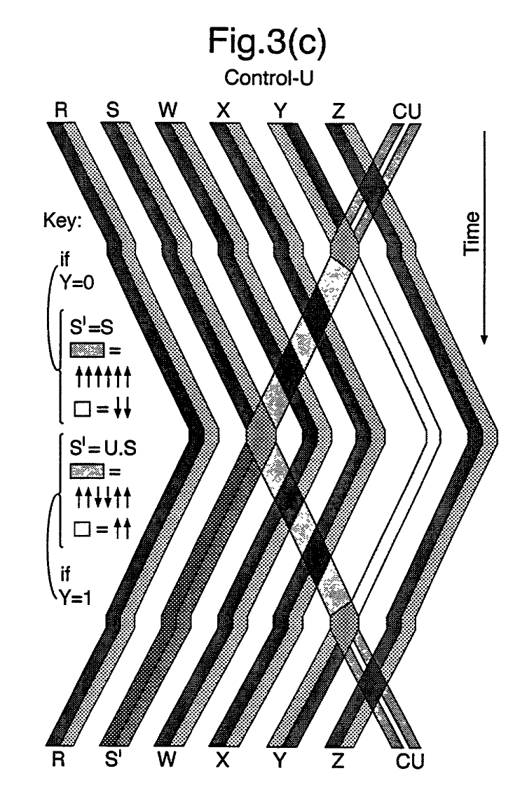

FIGS. 3a, 3b and 3c are schematic diagrams of the processor in FIG. 1 undergoing state transformations to apply a conditional logical operation to a particular data bit;

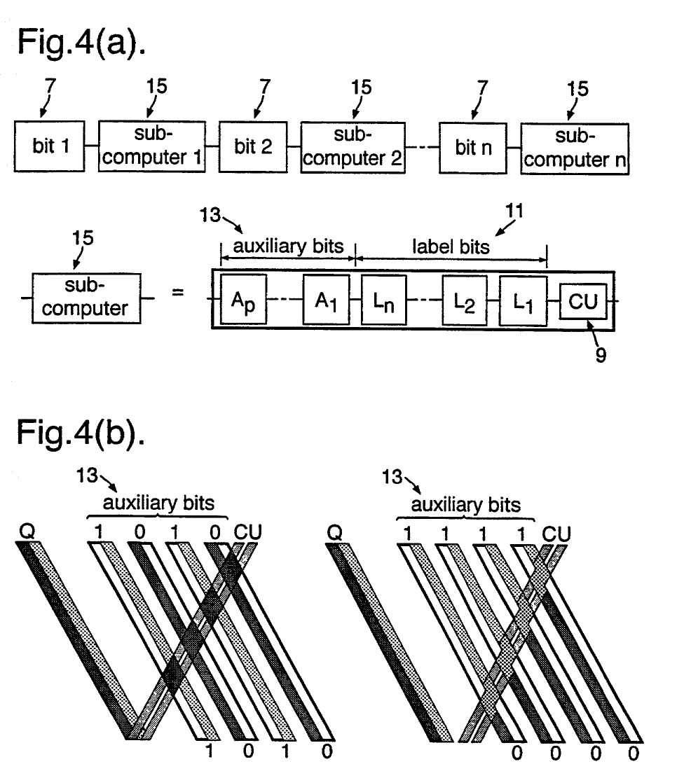

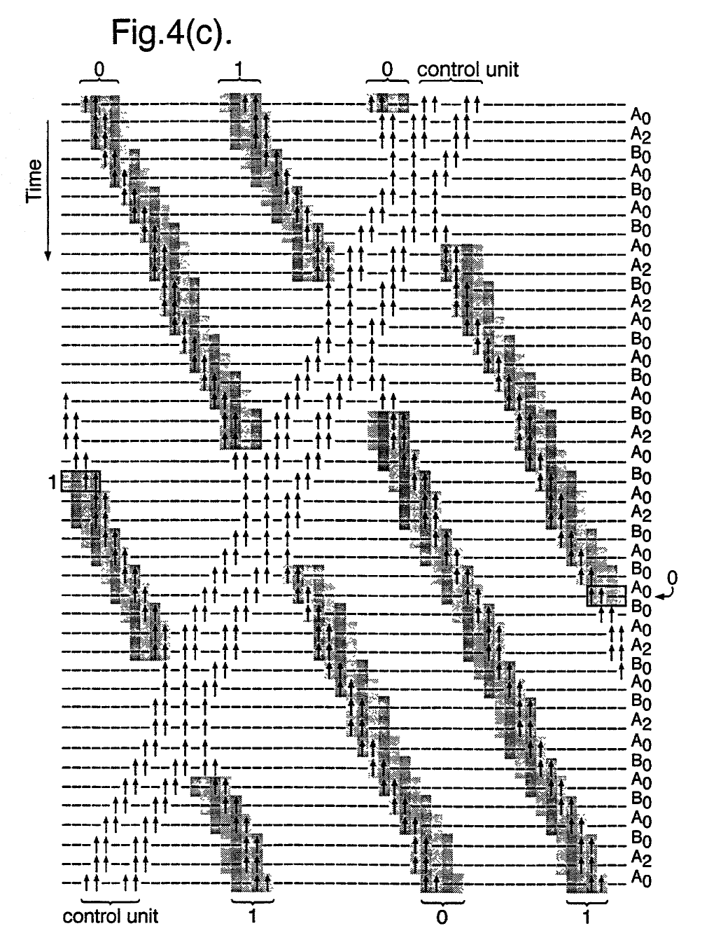

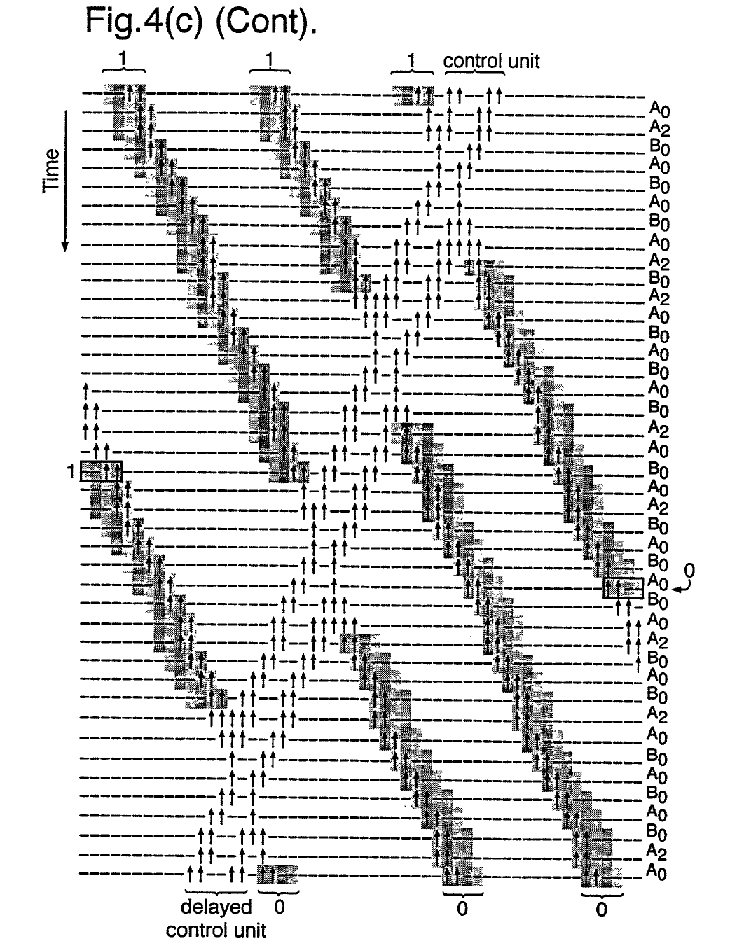

FIGS. 4a, b and c schematically illustrate a second embodiment of the invention and the performance of a logical operation using it; and

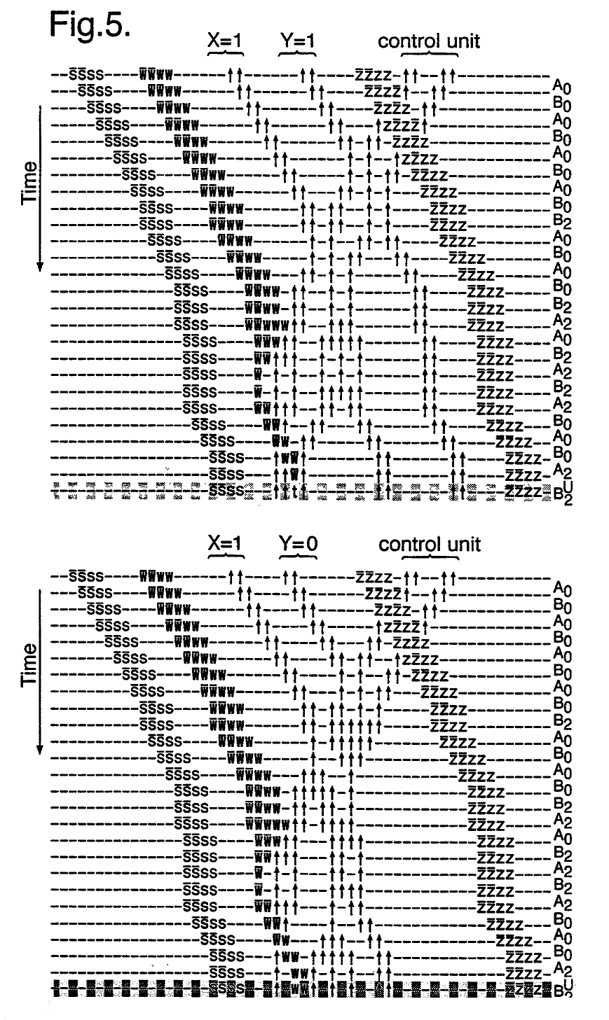

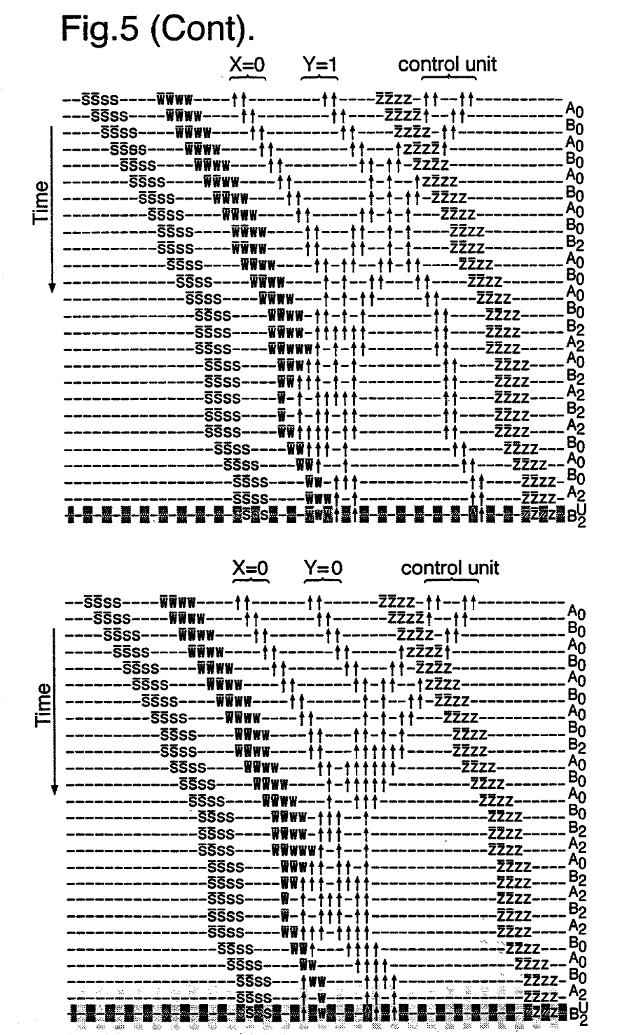

FIG. 5 illustrates schematically a further logical operation using the processor of FIG. 1.

As illustrated in FIG. 1 a data processor 1 according to an embodiment of the invention consists of a one dimensional array (i.e. a line) of unit cells of alternating type A and B. Although only eight unit cells are illustrated in FIG. 1, the dotted line at 4 indicates that the data processor can be of arbitrary length. The array, of course, has two ends: one a unit cell of type A, labelled 3a, and one a unit cell of type B, labelled 5a. The unit cells at the ends differ from those in the middle in that they each only have one neighbour whereas the unit cells of type A and B in the middle of the array, labelled 3 and 5 respectively, have two neighbours each (of the opposite type). As will be explained later, this difference provides for a method of loading data onto the illustrated data processor 1.

As indicated in FIG. 1, and as will be explained below, the unit cells do not each store a different data bit. Instead a data bit is encoded by the pattern of states of four adjacent unit cells, two of type A and two of type B.

In the illustrated array each cell has two internal states |↓> and |↑>. (In the quantum implementation these are eigenstates and each unit cell can represent any quantum superposition of these states.) Each bit of information is represented by four consecutive unit cells in the following way: a binary zero is represented by |↑↑↓↓> whilst a binary one is represented by |↓↓↑↑>. The representation of a bit X of either value can therefore be compactly written as \overline{xx}xx, where x corresponds to ↓ if X=0 and ↑ if X=1, with the opposite applying to \overline{x}.

FIG. 2 illustrates this arrangement schematically in a longer array than the one shown in FIG. 1. In FIG. 2a there are several unit cells 7, with the state indicated by a downwards arrow, separating each pair of bits or qubits. Three such bits x, y and z are shown loaded onto the data processor. In order to carry out logical operations the array is subjected to updates which are illustrated in the drawings and explained below. For the updates the notation A_{ƒ}^{U} will be used which means that each cell of type A is subjected to unitary transform U if, and only if, its “field” has valueƒ. When the U is omitted a simple inversion is implied, |↓>⇄|↑>. The “field” is defined as the number of nearest neighbours in state it |↑> minus the number in state |↓>.

The way in which such updates are applied in practice depends on the way in which the processor is implemented. For instance, in the quantum implementation with the unit cells being the spins of two types of atomic nuclei in a molecule, the updates are performed using NMR techniques which can, by selecting the frequency of illuminating e.m. radiation to correspond to the resonant frequency of the desired cell type, be arranged to flip the spins of either the cells of type A or type B, depending on the states of the nearest neighbours of that cell. In a classical implementation, on the other hand, with the unit cells being an array of Boolean variables, the updates are simply applied to the array using program instructions addressing the desired variables.

Because the array as illustrated is structurally regular, and the updates are sent to all unit cells (of a particular type) globally, it is necessary, as with the scheme of Lloyd, to introduce a special “control unit” onto the array in order to be able to select a particular bit for manipulation or transformation. In FIG. 2a the control unit (CU) is illustrated as six consecutive unit cells 9 in a pattern with the first pair and the last pair in the same state (illustrated by an upwards arrow) and the middle pair in the opposite state (illustrated by a downwards arrow). In this embodiment this control unit only exists in one place along the array. The effect of this control unit will be seen in the explanations of logical operations below.

FIG. 2a illustrates the effect of applying a simple transformation B₀. It will be appreciated from the definition above that this update addresses all unit cells of type B, and invert the state of those for whom the “field value” is zero (i.e. where the number of neighbours in the up state minus the number of neighbours in the down state is zero). Looking in detail at FIG. 2a, therefore, it can be seen that the left hand most unit cell of the data bit x is a unit cell of type B, so is addressed by this transformation. Its left hand neighbour is in the downwards state while its right hand neighbour is in the upwards state, thus the “field” is the number of nearest neighbours in the up state (1) minus the number in the down state (1) giving zero. This satisfies the field value in the transformation B₀ and so the transformation (in this case a simple inversion) is carried out on that unit cell. The transformed state is illustrated in the lower line in FIG. 2a.

This same process being applied to each of the unit cells of type B in the array has the effect, as shown in the lower line of FIG. 2a, of moving each data bit one unit cell to the right, while moving the control unit one unit cell to the left.

FIGS. 2b and 2c illustrate the use of the control unit and further updates to move the control unit relative to the data. It can be seen that the sequence of updates A₀ and B₀ applied alternately move the data bits to the right and the control unit to the left. For clarity in FIG. 2b (and the subsequent figures) downwards arrows are omitted so that the cells marked “-” are in the downwards state. The white unit cells are of type A and the shaded ones of type B. It can be seen in FIG. 2b that the control unit passes through the bit Z, leaving it unchanged, and continues until mid-way through passing bit Y. Then a new sequence of updates is applied: B₂, A₂, A₀, B₂, A₀, B₂^{u}. It will be appreciated from FIG. 2 that only the cell that represents the Y bit is subject to the last update, B₂^{u}. Thus Y is transformed, yielding T=U.Y. Then the updates preceding the last are re-applied in reverse order in order to move the control unit away from the newly transformed bit; this is shown in FIG. 2c where the whole process is indicated diagrammatically for clarity. These operations, shown in FIG. 2, implement a general “1-bit” gate.

To perform useful logical operations it is also necessary for the data processor to be able to act as a two-bit gate. FIGS. 3a and 3b illustrate a “control-U” which is effective to apply the transform U to a certain bit (referred to as the target) if, and only if, a second bit (the control) is in state 1. FIGS. 3a and 3b illustrate the individual unit cells and their states in the same manner as FIG. 2b, while FIG. 3c illustrates the process in the more diagrammatic way of FIG. 2c. In FIGS. 3a and 3b the target bit is S, and the control Y. The control unit moves transparently past the Z bit, and continues until mid-way through passing Y. To this point is the process is identical to FIG. 2c, however now the control unit itself is subject to a transformation by the update B₂: it is altered from ↑↑↓↓↑↑ to ↑↑↑↑↑↑ if, and only if, Y=0. FIG. 3a shows the situation when Y=0 and FIG. 3b shows the corresponding situation when Y=1. Both forms of the control unit will pass transparently through bits under the same update sequence, thus the control unit moves past intervening bits W, X regardless of whether it has transformed. When S is reached a new sequence of updates is applied starting B₂, A₂, and the last of which B₂^{U}, subjects S to a transform U if, and only if, the control unit arrived in its unaltered form. Thus the last update B₂^{u} only has an effect if Y=1. Finally the updates preceding the last are reapplied in reverse order so as to return the control unit to its initial state.

It is also possible to provide a “control-control-U” gate in which the application of the transform depends upon the states of two control bits. These processes are illustrated in FIG. 5 with X and Y as the control bits, for the four combinations of possibilities: X=1, Y=1; X=0, Y=1; X=1, Y=0; and X=0, Y=0.

The gates so far described are sufficient to efficiently implement any quantum or classical algorithm.

The above explanations have assumed that the array is already loaded with the data and the control unit. As briefly mentioned already, one way in which the data can be loaded is by utilising the cells at the end of the array, for whom the possible values of the field variable are 1 and −1 in contrast to the possible value of −2, 0 and 2 for all other cells. Thus the updates A₋₁, A₁, B₋₁, B₁ are effective to manipulate the states of the unit cells on the end to place them in a desired state. The other normal updates can then be used to shift-load these states into the centre of the array.

The way in which data is output depends on the implementation and the measurement techniques. If a cell on one end is associated with a measuring device, then the bit of data to be measured can be swapped with the bit nearest the end (by a series of updates as discussed above) and then moved to the end cell by the reverse of the input technique. Alternatively, in the classical implementation, the values of the array can simply be read. With a quantum implementation a superior output procedure is possible if each cell has a third state “→” exhibiting rapid spontaneous decay to the ↓ state. Then the state of a qubit anywhere along the array can be measured using the 1-qubit gate of FIG. 2b and choosing:

$$U = ( \begin{matrix}001 \\ 010 \\ 100\end{matrix} ) in the basis \{ ↓ , ↑ , \to \} .$$

If the subject qubit was previously in state 1, then the transformation would leave its representative cells in the unstable state →. From there they would decay back to |↓> with an emission of radiation. The presence (or absence) of this emission can be detected and used to infer the state of the qubit. Repeated application of the transform produces a stream of emissions (i.e. a fluorescence), thus increasing the detection efficiency.

The above embodiments has used only one control unit in the data processor. Thus it is not possible to apply a gate operation at several points simultaneously. It is, of course, possible simply to load several control units along the array (e.g. one every 20 bits) and to apply identical gate operations simultaneously at every control unit (at every step).

A superior alternative, though, which allows control units along the array to be effectively switched on and off during the computational process is illustrated in FIG. 4. In FIG. 4 the spacing between the data bits 7 in the array is increased considerably, and in each space a control unit 9 is put, together with a set of additional bits, some of which, labelled 11, encode a label (for instance labelling each space uniquely) and others, labelled 13, forming an auxiliary “work-pad”. Together the control unit and the additional bits effectively constitute a sub-computer 15 in the space between each data bit 7.

With this arrangement if a specific one or two bit gate G needs to be applied simultaneously at points P along the array of N bits, an initial update sequence is applied simultaneously to the array to enable or disenable the control units at points other than P. This is achieved by using the label bits as the input, the output being a binary variable represented by some transformation which is applied or not applied to the control unit. When subsequent updates are applied to move the control units away from the sub-computers to perform the gate operation G on neighbouring bits (in the manner of the first embodiment), this only occurs for those control units which are not disabled. An example of a transformation which can disable a control unit is shown in FIG. 4b and 4c. In this sequence a control unit is “disabled” by delaying it so that it is in an empty region of the array when a different, non-delayed, control unit has reached its target bit. FIG. 4b illustrates the sequence in a compact schematic style, the actual updates being shown in FIG. 4c. In the left side of FIGS. 4b and c the auxiliary bits are set to 1010 and the control unit reaches the “target” data bit Q. But on the right-hand side of FIGS. 4b and c the auxiliary bits are set to 1111 and after the same sequence of updates the control unit has not reached the target bit Q. After the desired gate operation has been applied, the updates can be reversed to return the sub-computers 15 to their initial state.

There are a number of potential variations: (a) place a “sub-computer” only every ten bits, for example; (b) “nest” the procedure to provide parallel computation within the “sub-computers” at a cost of 1n(1n(N)), by arranging for each region of the data processor hitherto containing a single control unit and its associated label bits to be extended to include additional control units and labels so as to provide parallel computation within that region; (c) generalise the process performed by the “sub-computer” to apply a range of transformations to the control unit, corresponding to different subsequent gate operations on the data bits; (d) in the quantum implementation make the label bits and the auxiliary bits associated with each control unit into qubits, so that the computation determining which control units are disabled becomes a quantum process producing control units in a superposition of the enabled/disabled state.

It will be appreciated that this parallel implementation is not limited to the ABABAB . . . type of processor with only two types of unit cell, but is also applicable to any scheme using a control unit, such as the ABCABCABC . . . scheme propose by Seth Lloyd and mentioned in the introduction.

As mentioned above the data processor of the invention can be implemented either as a quantum computer or as a classical computer. In the implementation as a classical computer the unit cells forming the data processor could exist physically, for example each could be realised as a single micro-chip, or the cells could be implemented in software as a stored array of Boolean variables, one variable for each unit cell.

In more detail a data processor having N unit cells would be represented by an array with N Boolean variables. Referring to each variable as R(i), where R(i)=0 corresponds to a cell in state 1 and R(i)=1 corresponds to a cell state 1, the cells of type A are stored as the variables R(i) with i an odd number. The cells of type B are those Boolean variables R(i) with i even. In this case the updates mentioned above for cells of type A and B are straightforward software routines. For instance the program to implement the rule B₀ is as follows:

Definition of Procedure ″Beta_Zero″:

Set loop=2
Repeat the following until loop=N

If (R[i−1]=1 and R[i+1]=0) or (R[i−1]=0 and R[i+1]=1)

then set R[i]=1−R[i];

Set loop=loop+2;

End of repeated section

End of Procedure Definition

And similarly the part to implement the rule A₂ is:

Definition of Procedure ″Alpha_two″:

Set loop=3
Repeat the following until loop>N:

If (R[i−1]+R[i+1]=2) then set R[i]=1−R[i];
Set loop=loop+2;

End of repeating section

End of Procedure

In order to “run” the processor the list of updates (e.g. the list shown down the right hand side of FIGS. 2a, b, 3a, b, 4c and 5) needed to perform a particular operation are stored e.g. in a disk file, and then a main routine is run by the computer's processor as follows:

Look at the first update in the list of updates.
Repeat the following until the end of the list of updates is reached:

If current update is ″A0″ then apply procedure alpha_zero

Otherwise if current update is ″A1″ then apply procedure
alpha-one ...etc.

Otherwise if current update is ″B2″ then apply
procedure beta_two

Look at next update in the list of updates.

End of repeat loop.

As regards quantum implementations, the fact that the present invention involves only two types of unit cell makes implementation using the current NMR approaches (e.g. based on long hydrocarbon molecules possessing a number of spin-non-zero nuclei as unit cells) considerably easier because only two addressable types of unit cell are needed. The relaxation on the requirement for how the unit cell reacts to its neighbours, in that each cell only needs to react to the number of neighbours in one state minus the number in the other (rather than needing to “know” which neighbour is in which state) also reduces the difficulties of implementation. A solid state implementation is also possible in which the unit cells are again represented by the state of nuclei spins, but in donor impurity atoms embedded in silicon. Previously such solid state implementations of quantum computers have proposed the use of electrostatic gates near the donor impurities to control specific qubits. However these electrodes represent a principle source of decoherence in the system, and also increase the difficulty of construction. With the present invention, it is only necessary to address qubits globally, not individually, and so the role of the individual electrodes for addressing individual qubits is removed.

1. A data processor comprising an array of unit cells of only two different types, the two different types of unit cell being arranged alternately in the array, each unit cell having first and second distinguishable states, and means for independently addressing the two types of unit cell with a state transformation signal to which each addressed unit cell responds by undergoing a state transformation selectively in dependence upon the states of its nearest neighbours in the array.

2. A data processor according to claim 1 wherein the state transformation is applied in dependence upon whether the addressed unit cell's nearest neighbours are in mutually the same state or mutually different states.

3. A data processor according to claim 1 or 2 wherein the means for independently addressing the two types of unit cells addresses each type of unit cell by applying to the whole array the state transformation signal in the form of a physical stimulus to which unit cells of the other type are substantially inert.

4. A data processor according to claim 1, 2 or 3 wherein the array is one dimensional, consisting of a line of unit cells of alternating type.

5. A data processor comprising an array of unit cells of different types, there being a plurality of cells of each of said different types, each unit cell having first and second distinguishable states, and means for independently addressing the different types of unit cell with a state transformation signal to which each addressed unit cell responds by selectively undergoing a state transformation in dependence upon whether its nearest neighbours are in mutually the same state or mutually different states.

6. A data processor according to claim 1, 2, 3, 4 or 5 wherein data bits are represented on the array as patterns of said first and second states, each data bit being represented by a pattern of states formed by a plurality of adjacent unit cells.

7. A data processor according to any one of claims 1 to 6 wherein each data bit is represented by a pattern of states formed by four adjacent unit cells.

8. A data processor according to claim 7 wherein the data bits are binary data bits with a binary one being represented by a first adjacent pair of said four adjacent unit cells being in a first state and the second pair being in a second state.

9. A data processor according to any one of the preceding claims further comprising at least one of:
first means for simultaneously addressing all unit cells of the array with a state transformation signal to which all the unit cells respond;
second means for simultaneously addressing all unit cells of the array with a state transformation signal to which the unit cells respond in dependence on the states of their nearest neighbours;
third means for addressing all unit cells of one of said different types in the array with a state transformation signal to which all the unit cells of said one type respond.

10. A data processor according to any one of the preceding claims wherein the state transformation switches the state of the unit cell between said first and second distinguishable states.

11. A data processor according to any one of the preceding claims further comprising loading means for loading data onto the array by applying a first state transformation to a unit cell on the edge of the array to set it into a desired state and a second state transformation to move the data to a neighbouring unit cell within the array by transforming said neighbouring unit cell into the same state.

12. A data processor according to claim 11 wherein the loading means loads data bits onto the array such that they are separated by a predetermined number of unit cells which are in a selected one of said states.

13. A data processor according to claim 11 or 12 wherein the loading means is operable to load a control unit onto the array, the control unit comprising a predetermined pattern of states of a plurality of adjacent unit cells.

14. A data processor according to claim 13 wherein the control unit comprises a predetermined pattern of states of six adjacent unit cells.

15. A data processor according to claim 14 wherein the predetermined pattern of states is “110011” where each digit represents the state of a corresponding one of the six adjacent unit cells and “1” and “0” represent the two different states.

16. A data processor according to claim 13, 14 or 15, wherein there are a plurality of control units each having associated with it a set of states constituting a label such that each of said plurality of control units may be independently manipulated by a computational process involving each control unit and its label.

17. A data processor comprising an array of unit cells of different types, there being a plurality of cells of each of said different types, each unit cell having first and second distinguishable states, and means for independently addressing the different types of unit cell with a state transformation signal to which each addressed unit cell responds by selectively undergoing a state transformation in dependence upon the states of its nearest neighbours, the processor further comprising means for loading a plurality of control units onto the array by setting selected unit cells on the array into predetermined states such that state transformation signals applied to the array cause said state transformations in dependence upon the position of the control units, each of said control units having associated with it a set of states constituting a label such that each of said plurality of control units may be independently manipulated by a computational process involving each control unit and its label.

18. A data processor according to claim 16 or 17 wherein the label comprises a plurality of unit cells adjacent the control unit.

19. A data processor according to claim 16 or 17 wherein each of said plurality of control units also has associated with it a plurality of adjacent unit cells set into a predetermined state.

20. A data processor according to any one of claims 16 to 19 wherein pairs of adjacent control units are mutually separated by a plurality of data bits.

21. A data processor according to any one of claims 16 to 20 wherein each region of the data processor hitherto containing a single control unit and its associated label bits is extended to include additional control units and labels so as to provide parallel computation within that region.

22. A data processor according to any one of claims 16 to 21 wherein a plurality of different transformations are applicable to the control units corresponding to different subsequent operations on the data bits.

23. A data processor according to any one of claims 16 to 22 wherein the labels and auxiliary bits associated with each control unit are represented by quantum system s in a quantum superposition of states, whereby the control units may be in a superposition of an enabled and disabled state.

24. A data processor according to any one of the preceding claims wherein said unit cells are Boolean variables in an array stored in the memory of a computer.

25. A data processor according to any one of claims 1 to 22 wherein the unit cells are quantum systems and said distinguishable states are different eigenstates of the system such that each unit cell can be in a quantum superposition of the distinguishable states.

26. A data processor according to claim 23 or 25 wherein the state transformation is a unitary transform.

27. A data processor according to claim 23, 25 or 26 wherein the quantum systems are non-zero-spin nuclei of a molecule, said distinguishable states being different spin states, said state transformations being effected by illumination of the array with electromagnetic radiation of a frequency selected to flip the spin of the unit cells to be addressed.

28. A data processor according to claim 23, 25 or 26 wherein the quantum systems are non-zero-spin nuclei of donor impurity atoms in a semiconductor.

29. A data processor constructed and arranged to operate substantially as hereinbefore described with reference to and as illustrated in the accompanying drawings.
